(19) United States
(12) Patent Application Publication
(10) Pub. No.: US 2009/0308160 A1
(43) Pub. Date: Dec. 17, 2009

(54) VERTICAL ACCELERATION MEASURING APPARATUS

(75) Inventors: Chang Han Je, Daejeon (KR); Chang Kyu Kim, Incheon (KR); Chang Auck Choi, Daejeon (KR)

Correspondence Address: AMPACC LAW GROUP, 3500 188th St. SW, Lynnwood, WA, 98037, US

(73) Assignee: Electronics and Telecommunications Research Institute, Daejeon (KR)

(21) Appl. No.: 12/355,644

(22) Filed: Jan. 16, 2009

(30) Foreign Application Priority Data
Jun. 16, 2008 (KR) 10-2008-56396

(51) Int. Cl. G01P 15/125

(52) U.S. Cl. 73/514.32

(57) ABSTRACT

Provided is a vertical acceleration measuring apparatus including a substrate; a plumb that is separated from the substrate to operate; a plurality of movable electrode plates that are formed at an upper end of the plumb in a predetermined direction; a movable electrode plate supporting portion that is formed at the upper end of the plumb and supports the movable electrode plates; a fixed body that is formed at an upper end of the substrate; a fixed electrode plate supporting portion that is coupled to the fixed body adjacent to the upper end of the plumb; a plurality of fixed electrode plates that are supported by the fixed electrode plate supporting portion and arranged to face the movable electrode plates in parallel; and a connection spring that connects the fixed body and the movable electrode plate supporting portion.

### CROSS-REFERENCE TO RELATED APPLICATION

This application claims priority to and the benefit of Korean Patent Application No. 2008-56396, filed Jun. 16, 2008, the disclosure of which is incorporated herein by reference in its entirety.

### BACKGROUND

1. Field of the Invention

The present invention relates to a vertical acceleration measuring apparatus, and more specifically, to a capacitive vertical acceleration measuring apparatus in which an error is not caused by acceleration generated in a different direction.

This invention was supported by the IT R&D program of MIC/IITA [2006-S-054-02, Development of Ubiquitous Complementary Metal-Oxide Semiconductor (CMOS)-based Micro-Electro-Mechanical Systems (MEMS) Composite Sensor].

2. Discussion of Related Art

In a capacitive acceleration measuring apparatus using the MEMS technique, relative motion between a plumb and a substrate occurs when acceleration is generated, and a change in capacitance corresponding to the relative motion is measured.

So far, devices for measuring acceleration applied in the horizontal direction to a semiconductor substrate have been mainly developed because a process of manufacturing the devices is easy to perform, and the devices can be easily expanded into two-axis acceleration sensors and applied in various fields. Recently, since the need for a three-axis acceleration sensor on one substrate is increasing, devices for measuring acceleration applied in a direction perpendicular to a substrate are being researched. A device for measuring acceleration applied in a direction perpendicular to a substrate by using a change in capacitance may have a structure in which measurement electrodes are disposed in a plane parallel to a substrate or a structure in which measurement electrodes are disposed in a plane perpendicular to a substrate. In the former structure, two electrodes are disposed spaced apart and facing each other in a plane parallel to the substrate, one electrode is connected to a plumb so as to be moved by external acceleration, and the other electrode is connected and fixed to the substrate. In this state, when acceleration is applied from outside in a direction perpendicular to the substrate, a distance between the two electrodes changes, and a change in capacitance caused by the distance change is measured. In the latter structure, two electrodes having different heights are disposed spaced apart and facing each other in a plane perpendicular to the substrate, one electrode is connected to a plumb, and the other electrode is connected to the substrate. In this state, when acceleration is applied from outside in a direction perpendicular to the substrate, the facing area between the two electrodes changes, and a change in capacitance caused by the change of the facing area is measured. The change in capacitance is non-linear in the former stricture and linear in the latter structure. Therefore, it is advantageous to use the latter structure in terms of the manufacturing process and circuit configuration.

To use the simplest circuit, a movable electrode is set to have the same height as a fixed electrode, and a change in capacitance between the two electrodes is measured. However, in order to remove noise and obtain more precise measurements, the entire region is divided in two regions, and a difference in capacitance between the two regions is calculated. That is, a positive voltage +V is applied between the movable electrode and the fixed electrode at one side, and a negative voltage −V is applied between the movable electrode and the fixed electrode at the other side. Then, a difference in capacitance between the two regions is calculated. In this case, when all the electrodes have the same height, acceleration applied in an upward direction perpendicular to the substrate and in a downward direction perpendicular to the substrate have the same output value, and thus the directions cannot be discriminated from each other. Therefore, in one region, the movable electrode is set to have a smaller height than the fixed electrode, and in the other region, the fixed electrode is set to have a smaller height than the movable electrode. Then, the changes in capacitance have a different sign depending on the direction of the applied acceleration.

In acceleration sensors using such a structure which have been proposed so far, only a device layer placed on an oxide layer in a silicon-on-insulator (SOI) substrate has been used for simplifying a manufacturing process.

In such a conventional technique, it is difficult to precisely measure vertical acceleration with a small magnitude, because the weight of the plumb is low. Further, the acceleration sensor may malfunction due to horizontal acceleration. Such disadvantages will be described with reference to FIGS. 1 to 5.

FIG. 1 is a plan view of a conventional vertical acceleration measuring apparatus.

Referring to FIG. 1, the conventional vertical acceleration measuring apparatus includes a plurality of first fixed electrode plates 101, a plurality of second fixed electrode plates 103, a movable electrode plate supporting portion 105, a plurality of first movable electrode plates 107, a plurality of second movable electrode plates 109, a fixed body 111, a first fixed power contact 113, a second fixed power contact 115, and a movable power contact 117.

In FIG. 1, the fixed electrode plates 101 and 103 are fixed to a substrate. Therefore, when the entire apparatus is moved, the fixed electrode plates 101 and 103 are moved together. In FIG. 1, the first fixed electrode plates are arranged in the vertical direction and the second fixed electrode plates are arranged in the horizontal direction. On the contrary, a movable unit including the movable electrode plate supporting portion 105 and the movable power contact 117 is separated from a fixed unit including the fixed electrode plates 101 and 103 and the fixed body 111. When the entire apparatus is moved, the movable unit is affected by inertia. That is, the movable unit and the movable electrode plates 107 and 109 attached to the movable unit act like hanging handles in a bus—in the inertial reference frame of the bus, a force is applied to the handles in a direction opposite to movement of the bus. Such a force is measured through the electrode plates. When a voltage is applied between the movable electrode plates 107 and 109 attached to the movable unit and the fixed electrode plates 101 and 103 facing the movable electrode plates 107 and 109, the movable electrode plates and the fixed electrode plates serve as flat capacitors.

In this case, the capacitance between the plates facing each other is proportional to the overlapping area of the plates and inversely proportional to the distance between the plates. Therefore, when the facing area between the movable electrode plate and the fixed electrode plate differs while the movable unit is moved upward or downward, the capacitance there between also differs. Such a difference is used to measure acceleration.

FIG. 2 is cross-sectional views of the conventional vertical acceleration measuring apparatus.

The movable electrode plates of the conventional vertical acceleration measuring apparatus are divided into first movable electrode plates 107 and second movable electrode plates 109, and the fixed electrode plates facing the movable electrode plates are divided into first fixed electrode plates 103 and second fixed electrode plates 101. The movable electrode plates 107 and 109 are connected to a ground line, a positive voltage is applied to the first fixed electrode plates 103, and a negative voltage is applied to the second fixed electrode plates 101. Then, acceleration can be more precisely measured by using ΔC obtained by subtracting a capacitance change ΔC₂₁ between the second fixed electrode plate 109 and the first fixed electrode plate 103 from a capacitance change ΔC₁₂ between the first movable electrode plate 107 and the second fixed electrode plate 101. Further, the direction of the acceleration can be determined.

ΔC=ΔC₁₂−ΔC₂₁

In the conventional vertical acceleration measuring apparatus, the movable electrode plate supporting portion 105 and the first and second movable electrode plates 107 and 109 serve as a plumb. Since their heights are limited to several to several tens of μm, the weight of the plumb is very small. When the weight of the plumb decreases, so does the force of inertia. Then, a height change caused by vertical acceleration decreases, so that a capacitance change decreases. Therefore, it is not easy to measure the acceleration with precision.

Further, a vertical acceleration measuring apparatus responds only to vertical acceleration and must not respond to horizontal acceleration. However, since capacitance changes caused by lateral and longitudinal accelerations (X-axis and Y-axis directions in the orthogonal coordinate system) occur in the conventional vertical acceleration measuring apparatus, the apparatus may malfunction.

FIG. 3 is a schematic view for explaining the reason that the conventional vertical acceleration measuring apparatus malfunctions.

In FIG. 3, only those parts of the conventional vertical acceleration measuring apparatus that are required for measuring acceleration are illustrated.

The most important components of the vertical acceleration measuring apparatus are the electrode plates 101, 103, 105, 107, and 109 for measuring a capacitance change. As described above, the positions of the movable electrode plates 107 and 109 are changed by the movement of the movable unit including the movable electrode plate supporting portion 105, so that the capacitance changes. The capacitance change is used to measure the acceleration.

In FIG. 3, the movable unit can be moved side-to-side, forward and backward, and up and down, depending on the movement of the measuring apparatus. That is, the movable unit may be moved in the X- and Y-axis directions as well as the Z-axis direction, which is the vertical direction in the orthogonal coordinate system. In this case, a difference between capacitance changes caused by a change in a facing area 301 between the electrode plates or a distance 305 between the electrode plates should be 0. In the conventional vertical acceleration measuring apparatus, however, the difference is not 0.

FIG. 4 is a schematic view for explaining the reason that the conventional vertical acceleration measuring apparatus malfunctions in the lateral direction.

FIG. 4 shows a case in which acceleration is generated in the lateral direction, that is, the X-axis direction. When a force is applied in the direction of an arrow 400 (X-axis direction), the fixed unit is moved in the direction of the force, as described in FIG. 1. However, since the movable unit 105 is separated from the fixed unit, it is affected by the force of inertia.

Therefore, as seen in FIG. 4, when the movable unit is observed with respect to the fixed unit, the force is applied in the opposite direction to the movement.

Therefore, a displacement 410 occurs due to the acceleration. Accordingly, the facing area and distance between the fixed electrode plate and the movable electrode plate are changed by the displacement 410, so that a capacitance change occurs.

In this case, when a difference in the capacitance change ΔC is 0, the apparatus is stable for the force applied in the direction of the arrow 400. In a region 420 of FIG. 4, a distance between a fixed electrode plate and a movable electrode plate does not change, but facing areas 401 and 403 between the fixed electrode plates and the movable electrode plates change, so that the capacitance at each facing area changes. However, since the increase in capacitance between the left movable electrode plate and the fixed electrode plate is equal to the decrease in capacitance between the right movable electrode plate and the fixed electrode plate, a capacitance change ΔCₐᵣₑₐ obtained by adding the two values caused by the change in the facing area between the second movable electrode plate 109 and the first fixed electrode plate 103 becomes 0.

On the contrary, in a region 430 of FIG. 4, a facing area 417 between a fixed electrode plate and a movable electrode plate does not change, but distances 413 and 415 between the fixed electrode plates and the movable electrode plates change, so that the capacitance at each facing area changes. In this case, since the distance between the movable electrode plate and the left fixed electrode plate decreases, the capacitance increases. Further, since the distance between the movable electrode plate and the right fixed electrode plate increases, the capacitance decreases. Since the capacitance change is inversely proportional to the distance, the increase of the capacitance between the movable electrode plate and the left fixed electrode plate is larger than the decrease of the capacitance between the movable electrode plate and the right fixed electrode plate. Therefore, a capacitance change ΔC_{distance} obtained by adding the two values caused by the variation of the distance between the first movable electrode plate 107 and the second fixed electrode plate 101 becomes larger than 0.

That is, ΔC(=ΔC_{distance}−ΔCₐᵣₑₐ) becomes a positive number.

Therefore, since the overall capacitance changes with respect to the acceleration generated in the direction of the arrow 400, the vertical acceleration measuring apparatus may malfunction.

FIG. 5 is a schematic view for explaining the reason that the conventional vertical acceleration measuring apparatus malfunctions in the longitudinal direction.

FIG. 5 shows a case in which acceleration is generated in the Y-axis direction, that is, the direction of an arrow 500, in the conventional acceleration measuring apparatus. In this case, a change occurs in the reverse manner to the change occurring in FIG. 4.

When a force is applied in the direction of the arrow 500 in the conventional vertical acceleration measuring apparatus, a displacement 510 occurs opposite to the arrow direction. In this case, in a region 520 of FIG. 5, an area 513 between a fixed electrode plate and a movable electrode plate does not change. On the contrary, distances 501 and 503 between the fixed electrode plates and the movable electrode plates change, so that the capacitance changes. Therefore, ΔC_{distance} becomes a positive number.

In a region 530 of FIG. 5, a distance 505 between a fixed electrode plate and a movable electrode plate does not change, but areas 515 and 517 between the fixed electrode plates and the movable electrode plates change. Therefore, ΔCₐᵣₑₐ becomes 0.

In this case, ΔC does not become 0.

Therefore, the conventional vertical acceleration measuring apparatus may malfunction with respect to the acceleration generated in the direction of the arrow 500.

### SUMMARY OF THE INVENTION

The present invention is directed to a vertical acceleration measuring apparatus in which the weight of a plumb is increased to accurately measure vertical acceleration and which can minimize an error caused by acceleration applied in the horizontal direction.

According to an aspect of the present invention, a vertical acceleration measuring apparatus comprises a substrate; a plumb that is separated from the substrate to operate; a plurality of movable electrode plates that are formed at an upper end of the plumb in a predetermined direction; a movable electrode plate supporting portion that is formed at the upper end of the plumb and supports the movable electrode plates; a fixed body that is formed at an upper end of the substrate; a fixed electrode plate supporting portion that is coupled to the fixed body adjacent to the upper end of the plumb; a plurality of fixed electrode plates that are supported by the fixed electrode plate supporting portion and arranged to face the movable electrode plates in parallel; and a connection spring that connects the fixed body and the movable electrode plate supporting portion.

The plumb may be positioned inside a hole formed in the substrate. The movable electrode plates may include a plurality of first movable electrode plates and a plurality of second movable electrode plates having a smaller height than the first movable electrode plates, and the fixed electrode plates may include a plurality of first fixed electrode plates and a plurality of second fixed electrode plates having a smaller height than the first fixed electrode plates. Further, the movable electrode plates, the fixed electrode plates, the fixed body, the movable electrode plate supporting portion, the connection spring, and the fixed electrode plate supporting portion may be formed of a conductive material.

The vertical acceleration measuring apparatus may further comprise movable power contacts that are formed at the upper end of the fixed body; and fixed power contacts that are formed at the upper end of the fixed electrode plate supporting portion. The fixed power contacts may include a first fixed power contact to which a positive voltage is applied and a second fixed power contact to which a negative voltage is applied. The plumb may be formed of the same material as the substrate or of a material having higher density than the substrate. The longitudinal elastic coefficient of the connection spring may be larger than the lateral elastic coefficient thereof. The first fixed electrode plates may be arranged to face the second movable electrode plates, and the second fixed electrode plates may be arranged to face the first movable electrode plates.

The fixed electrode plates and the movable electrode plates may be arranged symmetrically in the up, down and side-to-side directions with respect to the center of the plumb. The plumb may be formed by etching the substrate. The substrate may include a silicon substrate, and an oxide layer may be formed at the upper end of the substrate.

The movable electrode plates, the movable electrode plate supporting portion, the fixed body, the fixed electrode plate supporting portion, the fixed electrode plates, and the connection spring may be formed at the upper end of the oxide layer. Further, a facing area between the movable electrode plate and the fixed electrode plate may change due to movement of the plumb. Further, capacitance formed between the movable electrode plate and the fixed electrode plate may change correspondingly to the change of the facing area. Further, capacitances generated between the movable electrode plates and the fixed electrode plates may be changed only by the vertical movement of the plumb.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a plan view of a conventional vertical acceleration measuring apparatus;

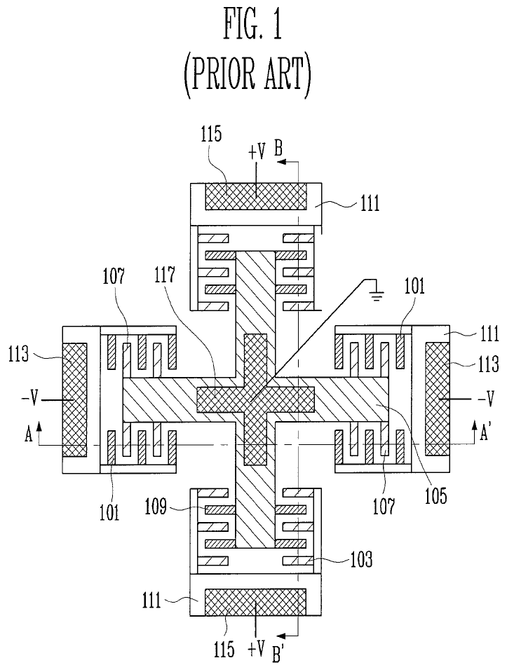

FIG. 2 is cross-sectional views of the conventional vertical acceleration measuring apparatus;

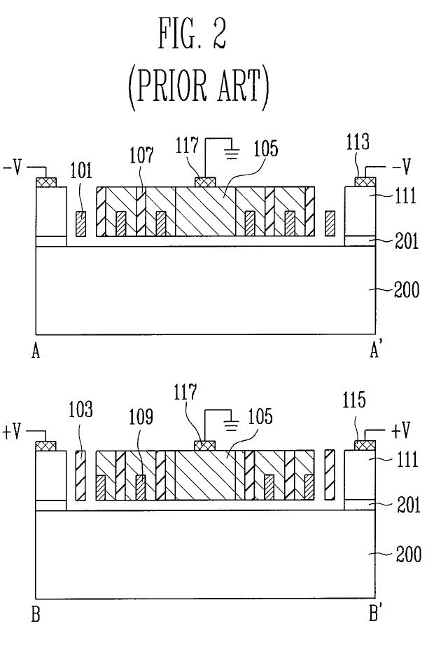

FIG. 3 is a schematic view for explaining the reason that the conventional vertical acceleration measuring apparatus malfunctions;

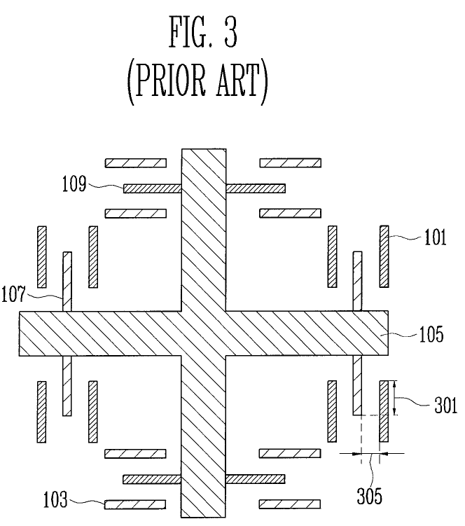

FIG. 4 is a schematic view for explaining the reason that the conventional vertical acceleration measuring apparatus malfunctions in the lateral direction;

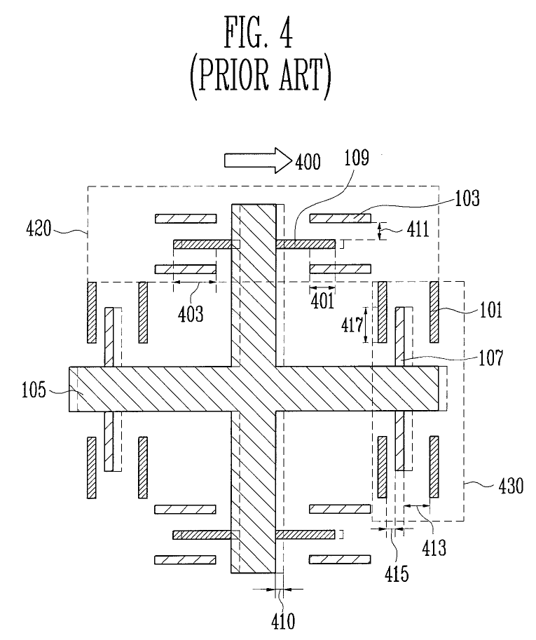

FIG. 5 is a schematic view for explaining the reason that the conventional vertical acceleration measuring apparatus malfunctions in the longitudinal direction;

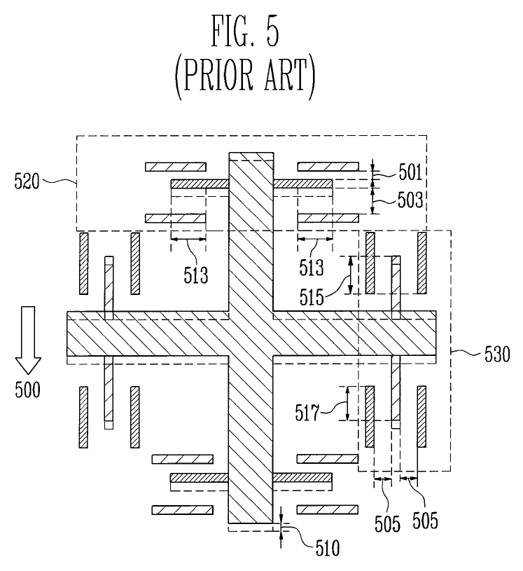

FIG. 6 is a plan view of a vertical acceleration measuring apparatus according to the present invention;

FIG. 7 is a diagram showing only a fixed unit of the vertical acceleration measuring apparatus according to the present invention;

FIG. 8 is a diagram showing only a movable unit of the vertical acceleration measuring apparatus according to the present invention;

FIG. 9 is cross-sectional views of the vertical acceleration measuring apparatus according to the present invention;

FIG. 10 is a diagram showing a specific example of the vertical acceleration measuring apparatus according to the present invention;

FIG. 11 is a diagram briefly showing the arrangement of electrode plates at the second and third quadrants on the basis of the center of a movable unit in the vertical acceleration measuring apparatus according to the present invention;

FIG. 12 is a diagram showing a case in which a lateral displacement occurs in the vertical acceleration measuring apparatus of the present invention; and

FIG. 13 is a diagram showing a case in which a longitudinal displacement occurs in the vertical acceleration measuring apparatus of the present invention.

### DETAILED DESCRIPTION OF EXEMPLARY EMBODIMENTS

Hereinafter, exemplary embodiments of the present invention will be described in detail with reference to the accompanying drawings.

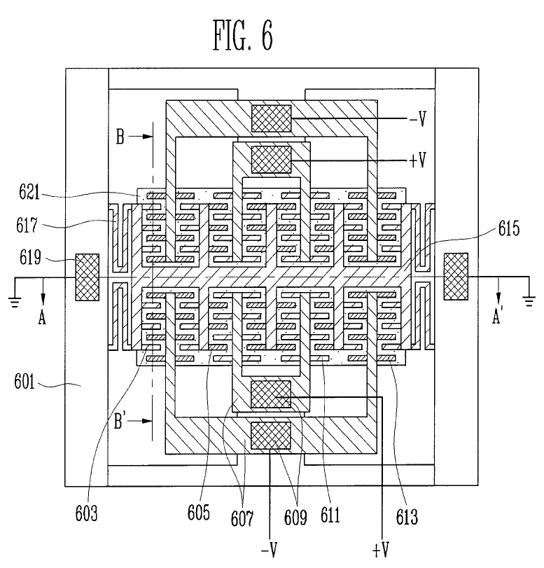

FIG. 6 is a plan view of a vertical acceleration measuring apparatus according to the present invention.

Referring to FIG. 6, the vertical acceleration measuring apparatus according to the present invention includes a fixed body 601 formed on a substrate, a connection spring 617, a movable electrode plate supporting portion 615, a plurality of first movable electrode plates 603, a plurality of second movable electrode plates 605, a plumb 621, movable power contacts 619, fixed power contacts 609, a fixed electrode plate supporting portion 607, a plurality of first fixed electrode plates 611, and a plurality of second fixed electrode plates 613.

The vertical acceleration measuring apparatus according to the present invention is manufactured by the MEMS process and formed by a method in which an oxide layer and a device layer are stacked on a silicon substrate and then etched.

The fixed body 601 serves to entirely support a fixed unit and a movable unit in the vertical acceleration measuring apparatus. The fixed body 601 is formed in the device layer on the silicon substrate and composed of a conductive material.

The connection spring 617 connects the fixed body 601 to the movable electrode plate supporting portion 615 and applies elasticity to the movable unit such that the movable unit including the movable electrode plate supporting portion 615, the plumb 621, and the movable electrode plates 603 and 605 can move. Further, the connection spring 617 is formed of a conductive material to deliver a current to the movable electrode plates.

The movable electrode plate supporting portion 615 is positioned at the upper end of the plumb 621 so as to support the movable electrode plates 603 and 605. The movable electrode plate supporting portion 615 is formed of a conductive material to supply a current to the respective movable electrode plates 603 and 605.

The first and second movable electrode plates 603 and 605 for measuring a displacement caused by acceleration are formed adjacent to the first and second fixed electrode plates 611 and 613 so as to face the first and second fixed electrode plates 611 and 613, respectively, and serve as flat capacitors. The first movable electrode plates 603 are formed to have a larger height than the second movable electrode plates 605 and are uniformly distributed on the upper end of the plumb. The movable electrode plates 603 and 605 are aligned in the same direction and are symmetrically formed in the up, down and side-to-side directions with respect to the center of the movable unit, while conventional electrode plates are divided into horizontal electrode plates and vertical electrode plates. Therefore, the quadrants of the movable unit with respect to the center of the movable unit are arranged in the same manner and the first and second movable electrode plates 603 and 605 are distributed in the same manner. That is, as seen in the drawing, the second movable plates 605 having a small size are arranged in four lines at the center of the movable unit, and the first movable plates 603 having a large size are arranged in two lines at either side of the movable unit.

The plumb 621 serves to apply mass to the movable unit for measuring acceleration in the vertical acceleration measuring apparatus according to the present invention. The plumb 621 may be included in the substrate, unlike in the related art. That is, even the substrate is etched in the MEMS process such that the plumb 621 is positioned in a hole formed in the substrate. Therefore, the plumb 621 is positioned in the substrate layer, different from the fixed body and so on. The plumb 621 may be formed of a substrate having a hole formed therein. Alternatively, the plumb 621 may be formed of a metallic material that is denser than the substrate so as to increase its weight, or a combination of the substrate and the metallic material. When the plumb 621 is used in such a manner, the weight of the plumb increases so that the force of inertia increases, and the vertical acceleration measuring apparatus is sensitive to low acceleration, unlike the related art in which the movable unit moves only at the upper end of the substrate. Therefore, it is possible to measure the acceleration more accurately.

The movable power contacts 619 and the fixed power contacts 609 are for supplying power to the movable electrode plates and the fixed electrode plates. The movable power contacts 619 are connected to a ground line. An inner fixed power contact connected to the first fixed electrode plates 611 is connected to +V, and an outer fixed power contact connected to the second fixed electrode plates 613 is connected to −V so as to measure acceleration by using AC obtained by subtracting a capacitance change ΔC21 between the second movable electrode plate 605 and the first fixed electrode plate 611 from a capacitance change ΔC12 between the first movable electrode plate 603 and the second fixed electrode plate 613.

The fixed electrode plate supporting portion 607 supports the first and second fixed electrode plates 611 and 613. The fixed electrode plate supporting portion 607 is formed in a shape having a plurality of branches extending from the fixed body 610 to the hole in which the movable unit is present. The fixed electrode plate supporting portion 607 supports the fixed electrode plates positioned at the upper end of the plumb of the movable unit such that the fixed electrode plates face the movable electrode plates, respectively. Further, the fixed electrode plate supporting portion 607 supplies power to the fixed electrode plates as well as the movable power contacts 619 to the movable electrode plates.

The first fixed electrode plates 611 and the second fixed electrode plates 613 are fixed to the fixed electrode plate supporting portion 607 and face the movable electrode plates in a state in which they are separated from the movable unit, thereby serving as flat capacitors of the respective electrode plates.

The first fixed electrode plates 611 are formed to have a larger height than the second fixed electrode plate 613, and the first movable electrode plates 603 are formed to have a larger height than the second movable electrode plates 605. The first fixed electrode plates 611 are arranged to face the second movable electrode plates 605, respectively, and the second fixed electrode plates 613 are arranged to face the first movable electrode plates 603, respectively.

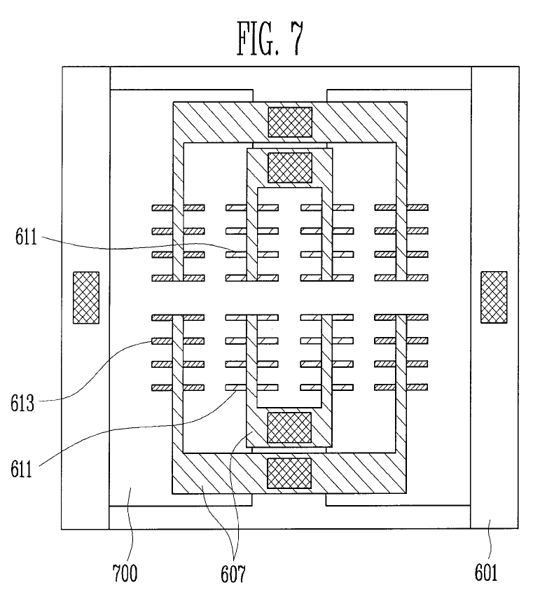

FIG. 7 is a diagram showing only the fixed unit of the vertical acceleration measuring apparatus according to the present invention.

Referring to FIG. 7, only the fixed unit which is not moved in the vertical acceleration measuring apparatus according to the present invention is illustrated.

The fixed unit includes the fixed body 601, the fixed electrode plate supporting portion 607, the first fixed electrode plates 611, and the second fixed electrode plates 613. The fixed unit is manufactured through the MEMS process such that a cavity is formed by etching the middle hole 700 of the fixed unit up to the substrate, unlike the conventional apparatus. Further, the other components of the fixed unit are manufactured using the device layer formed at the upper end of the substrate. The device layer is formed of a conductive material to conduct an electric current.

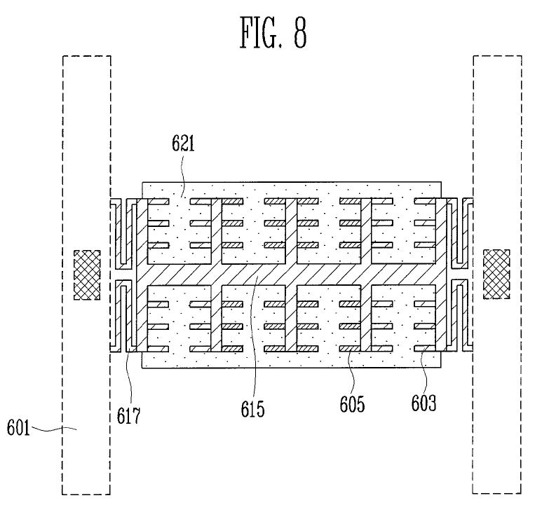

FIG. 8 is a diagram showing only the movable unit of the vertical acceleration measuring apparatus according to the present invention.

Referring to FIG. 8, the movable unit of the present invention includes the connection spring 617, the plumb 621, the movable electrode plate supporting portion 615, the first movable electrode plates 603, and the second movable electrode plates 605.

As shown in FIG. 8, the movable unit of the present invention is connected to the fixed unit through the connection spring 617 and can move up and down due to the elasticity of the connection spring and the weight of the plumb 612. The movable unit constructed in such a manner that can perform a horizontal motion as well as the vertical motion. However, the horizontal motion can be minimized by the stricture of the connection spring. That is, the vertical motion can be smoothly performed by reducing the thickness of the connection spring, and the horizontal motion can be minimized by increasing the width of the connection spring. In particular, the movable electrode plates may come in contact with the fixed electrode plates during the longitudinal motion, because a distance between them is small. Therefore, the elastic coefficient of the connection springs in the longitudinal direction is set to be larger than in the lateral direction such that the electrode plates do not contact each other, even though the longitudinal motion occurs. Alternatively, a structure may be inserted in such a manner that the movable unit can be moved in both the longitudinal and lateral directions only within a range smaller than the distance between the movable electrode plate and the fixed electrode plate. Then, it is possible to prevent the electrode plates from coming in contact with each other.

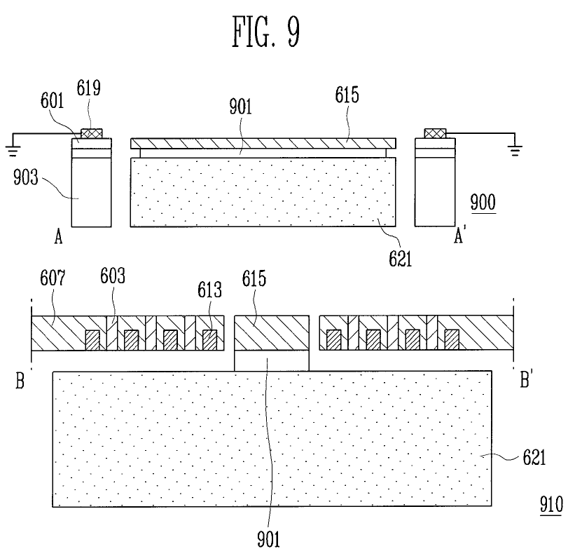

FIG. 9 is cross-sectional views of the vertical acceleration measuring apparatus according to the present invention, taken along lines A-A′ and B-B′ of FIG. 6.

FIG. 9 shows a cross-sectional surface 900 formed by the line A-A′ and a cross-sectional surface 910 formed by the line B-B′.

The cross-sectional surface 900 entirely shows the cross-sections of the fixed unit and the movable unit, and the cross-sectional surface 910 shows the arrangement of the movable electrode plates and the fixed electrode plates in detail.

On the cross-sectional surface 900, a coupling portion 901 is positioned at the lower ends of the fixed body 601 and the movable electrode plate supporting portion 615, and is formed of an oxide layer for coupling the substrate and the device layer. The coupling portion 901 is formed to couple the two layers while preventing charges supplied to the device layer from diffusing into the substrate.

The substrate may be divided into a substrate portion 903 fixing the fixed body and the plumb 621 of the movable unit which is separated from the substrate portion 903 through etching. The plumb 621 may be formed of a remaining portion after forming a hole in the substrate. However, a metallic material that is denser than silicon forming the substrate may be used to more smoothly operate the movable unit. Alternatively, silicon with metal deposited on it may be used.

The cross-sectional surface 910 shows a state in which the movable electrodes plates face the fixed electrode plates, respectively.

Referring to the cross-sectional surface 910, the fixed electrode plate supporting portion 607 is separated from the movable unit so as to be disposed above the movable unit. Further, the fixed electrode plates 613 supported by the fixed electrode plate supporting portion are also separated from the movable unit so as to be disposed above the movable unit. In this state, the movable electrode plates 603 facing the fixed electrode plates 613 are attached to the movable unit through the movable electrode plate supporting portion 615.

In this case, when the vertical acceleration is applied, the force of inertia is applied to the movable unit such that a vertical displacement occurs, and the facing area between each movable electrode plate and each fixed electrode plate included in the movable unit is changed by the displacement. Therefore, the vertical acceleration can be measured by measuring a capacitance change at this time.

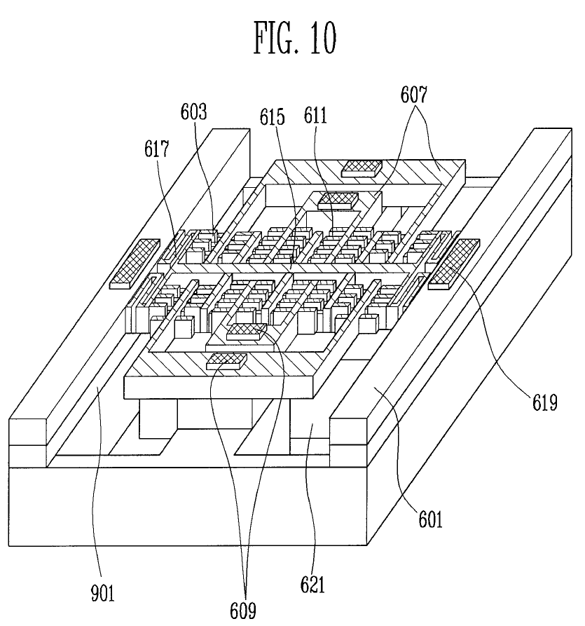

FIG. 10 is a diagram showing a specific example of the vertical acceleration measuring apparatus according to the present invention.

In FIG. 10, the vertical acceleration measuring apparatus according to the present invention is illustrated in three dimensions. As shown in FIG. 10, all components which conduct an electric current are positioned at the upper end of the coupling portion 901, and the fixed electrode plates are implemented in a form of being separated at the same height as the movable unit. Further, the arrangement of the electrode plates is divided into two sizes depending on the position thereof, and the magnitude and direction of the acceleration can be measured by measuring the capacitance change.

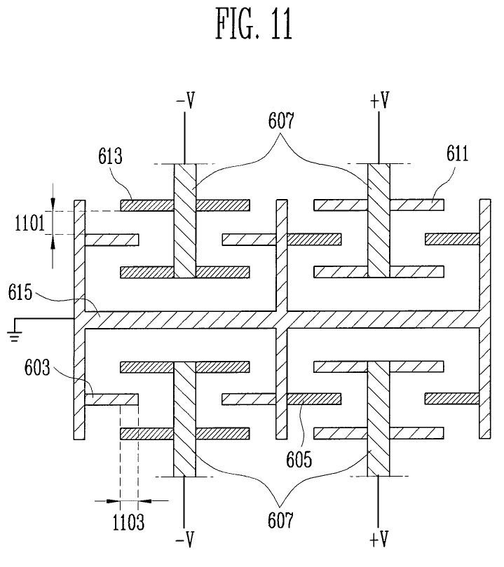

FIG. 11 is a diagram briefly showing the arrangement of the electrode plates at the second and third quadrants on the basis of the center of the movable unit in the vertical acceleration measuring apparatus according to the present invention.

Referring to FIG. 11, the fixed electrode plates attached to the fixed electrode plate supporting portion 607 are arranged in such a manner that the first fixed electrode plate 611 and the second fixed electrode plate 613 having a smaller size than the first fixed electrode plate 611 are alternately disposed, and the movable electrode plates are arranged in such a manner that the first movable electrode plate 603 and the second movable electrode plate 605 having a smaller size than the first movable electrode plate 603 are alternately disposed. Further, since the differently sized electrode plates are arranged to face each other, a difference between upward movement and downward movement can be detected, which makes it possible to detect whether the acceleration is upward or downward. In the case of the vertical displacement, the distances 1101 and 1103 between the electrodes do not change. Therefore, the capacitance is changed only by a change in the facing area in vertical direction between the electrodes.

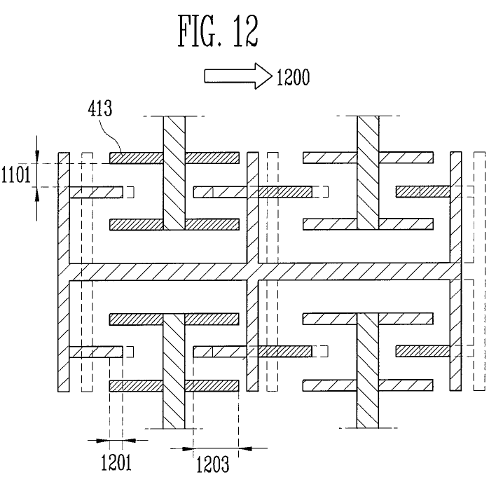

FIG. 12 is a diagram showing a case in which a lateral displacement occurs in the vertical acceleration measuring apparatus of the present invention.

In FIG. 12, when a force is applied in the direction of an arrow 1200, that is, the x-axis direction, the movable unit is moved in the opposite direction by the force of inertia. Accordingly, a distance 1101 does not change. Further, although an overlapping area 1201 decreases, an overlapping area 1203 on the opposite side increases as much as the overlapping area 1201 decreases. Therefore, a change in the overall capacitance becomes 0. Accordingly, although the acceleration is generated in the direction of the arrow 1200, a case in which it is wrongly recognized that vertical acceleration is applied does not occur.

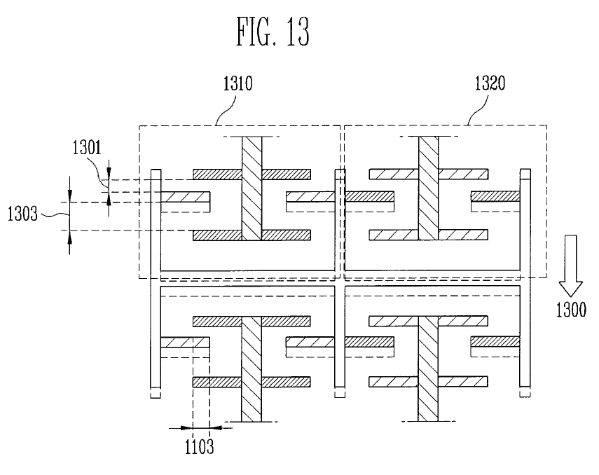

FIG. 13 is a diagram showing a case in which a longitudinal displacement occurs in the vertical acceleration measuring apparatus of the present invention.

In FIG. 13, when a force is applied in the direction of an arrow 1300, that is, the y-axis direction, the movable unit is moved in the opposite direction by the force of inertia. Accordingly, an overlapping area 1103 does not change. Meanwhile, a distance 1301 decreases and a distance 1303 increases. Since the increase in capacitance by the distance 1301 is not in direct proportion to the decrease in capacitance by the distance 1303, the sum of the two capacitance changes does not become 0. However, the same phenomenon occurs in a region 1320 as well as a region 1310, and a reverse voltage to that of the region 1310 is applied to the region 1320. Therefore, when a difference between the changes is calculated, the changes are offset. Accordingly, a change in the overall capacitance also becomes 0. As a result, the vertical acceleration measuring apparatus according to the present invention does not malfunction for change in the y-axis direction.

According to the present invention, the vertical acceleration measuring apparatus can measure vertical acceleration with greater precision than the conventional vertical acceleration measuring apparatus. Also, although acceleration is generated in a different direction from the vertical direction, the vertical acceleration measuring apparatus does not malfunction.

The present invention is not limited to the above-described example embodiment, and it will be understood by those skilled in the art that various changes in form and details may be made therein without departing from the spirit and scope of the present invention.

What is claimed is:

1. A vertical acceleration measuring apparatus comprising:
a substrate;
a plumb that is separated from the substrate to operate;
a plurality of movable electrode plates that are formed at an upper end of the plumb in a predetermined direction;
a movable electrode plate supporting portion that is formed at the upper end of the plumb and supports the movable electrode plates;
a fixed body that is formed at an upper end of the substrate;
a fixed electrode plate supporting portion that is coupled to the fixed body adjacent to the upper end of the plumb;
a plurality of fixed electrode plates that are supported by the fixed electrode plate supporting portion and arranged to face the movable electrode plates in parallel; and
a connection spring that connects the fixed body and the movable electrode plate supporting portion.

2. The vertical acceleration measuring apparatus according to claim 1, wherein the plumb is positioned inside a hole formed in the substrate.

3. The vertical acceleration measuring apparatus according to claim 1, wherein the movable electrode plates include a plurality of first movable electrode plates and a plurality of second movable electrode plates having a smaller height than the first movable electrode plates, and the fixed electrode plates include a plurality of first fixed electrode plates and a plurality of second fixed electrode plates having a smaller height than the first fixed electrode plates.

4. The vertical acceleration measuring apparatus according to claim 1, wherein the movable electrode plates, the fixed electrode plates, the fixed body, the movable electrode plate supporting portion, the connection spring, and the fixed electrode plate supporting portion are formed of a conductive material.

5. The vertical acceleration measuring apparatus according to claim 1, further comprising:
movable power contacts that are formed at the upper end of the fixed body; and
fixed power contacts that are formed at the upper end of the fixed electrode plate supporting portion.

6. The vertical acceleration measuring apparatus according to claim 5, wherein the fixed power contacts include a first fixed power contact to which a positive voltage is applied and a second fixed power contact to which a negative voltage is applied.

7. The vertical acceleration measuring apparatus according to claim 1, wherein the plumb is formed of the same material as the substrate or a material having higher density than the substrate.

8. The vertical acceleration measuring apparatus according to claim 1, wherein the longitudinal elastic coefficient of the connection spring is larger than the lateral elastic coefficient thereof.

9. The vertical acceleration measuring apparatus according to claim 3, wherein the first fixed electrode plates are arranged to face the second movable electrode plates, and the second fixed electrode plates are arranged to face the first movable electrode plates.

10. The vertical acceleration measuring apparatus according to claim 1, wherein the fixed electrode plates and the movable electrode plates are arranged symmetrically in the up, down and side-to-side directions with respect to the center of the plumb.

11. The vertical acceleration measuring apparatus according to claim 1, wherein the plumb is formed by etching the substrate.

12. The vertical acceleration measuring apparatus according to claim 1, wherein the substrate includes a silicon substrate, and an oxide layer is formed at the upper end of the substrate.

13. The vertical acceleration measuring apparatus according to claim 12, wherein the movable plates, the movable plate supporting portion, the fixed body, the fixed electrode plate supporting portion, the fixed electrode plates, and the connection spring are formed at the upper end of the oxide layer.

14. The vertical acceleration measuring apparatus according to claim 1, wherein a facing area between the movable electrode plate and the fixed electrode plate changes due to movement of the plumb.

15. The vertical acceleration measuring apparatus according to claim 14, wherein capacitance formed between the movable electrode plate and the fixed electrode plate changes correspondingly to the change of the facing area.

16. The vertical acceleration measuring apparatus according to claim 14, wherein capacitances generated between the movable electrode plates and the fixed electrode plates are changed only by the vertical movement of the plumb.
